(19) United States
(12) Patent Application Publication
(10) Pub. No.: US 2025/0109283 A1
(43) Pub. Date: Apr. 3, 2025

(54) ANTI-VIBRATION RUBBER COMPOSITION AND ANTI-VIBRATION RUBBER

(71) Applicant: KINUGAWA RUBBER IND. CO., LTD., Chiba-shi, Chiba (JP)

(72) Inventors: Norihiro HARADA, Chiba-shi (JP); Juria ENDOU, Chiba-shi (JP)

(21) Appl. No.: 18/825,643

(22) Filed: Sep. 5, 2024

(30) Foreign Application Priority Data
Sep. 8, 2023 (JP) 2023-145715

(51) Int. Cl. C08L 7/00; C08K 3/014; C08K 3/04; C08K 3/06; C08K 5/18; C08K 5/378; C08K 5/40

(52) U.S. Cl. CPC C08L 7/00; C08K 3/06; C08K 5/18; C08K 5/378; C08K 5/40; C08K 3/014; C08K 3/04; C08L 2205/025; C08L 2312/02

(57) ABSTRACT

In an anti-vibration rubber composition containing natural rubber (NR) and/or isoprene rubber (IR) and butadiene rubber (BR) as main rubber components, when the total rubber component is 100 parts by mass, it contains 1.8 to 5 parts by mass of 2-mercaptobenzimidazole zinc salt, 0.2 to 1.1 parts by mass of N,N′-Di-2-naphthyl-p-phenylenediamine, 0.2 to 0.7 parts by mass of sulfur as a vulcanizing agent and 2 to 7 parts by mass of tetrakis(2-ethylhexyl)thiuram disulfide as a sulfur donor compound.

### TECHNICAL FIELD

The present invention relates to an anti-vibration rubber composition that is used for anti-vibration rubber such as a bushing of a vehicle such as an automobile, and that has excellent anti-vibration characteristics against vibration, as well as excellent heat resistance (heat aging resistance) and heat settling resistance, and to an anti-vibration rubber having excellent heat resistance adhesive properties which is formed by using such the anti-vibration rubber composition.

### BACKGROUND TECHNOLOGY

Conventionally, in various types of vehicles such as automobiles, in order to improve passenger comfort, for example, various anti-vibration rubbers have been disposed at the source of vibration, so as to block or suppress vibration transmission, so as to reduce vibration and noise intrusion into the cabin, and so as to reduce noise diffusion into the surrounding environment.

It has been known that reducing a dynamic spring constant (Kd) is effective in improving the anti-vibration characteristics of anti-vibration rubber, namely, in blocking vibration transmission. However, since anti-vibration rubber is required to withstand a certain static force, such as supporting heavy objects, a static spring characteristic (Ks) is needed to be larger to some extent. Therefore, it is desirable that the value of dynamic magnification (=Kd/Ks), which is the ratio of the dynamic spring constant (Kd) to the static spring constant (Ks), is small (that is, low dynamic magnification). Furthermore, it is desirable for the anti-vibration rubber to have desired material properties, such as high durability against deformation due to repeated vibration.

In order to meet these performance requirements (low dynamic magnification and high durability), diene-based blend rubber (hereinafter is simply referred to as “diene rubber”) in which natural rubber (NR) and/or isoprene rubber (IR) and butadiene rubber (BR) are blended, is often used as a rubber component in anti-vibration rubber for vehicles. In addition, anti-vibration rubber is also required to have, for example, heat resistance (heat aging resistance) and heat settling resistance so as to withstand, for example, heat received from a heat source and a use in a severe heat environment. However, the diene-based rubber formed by blending natural rubber (NR) and/or isoprene rubber (IR) and butadiene rubber (BR) has been known to have poor heat resistance.

In order to solve this problem, various anti-aging agents and vulcanization systems (vulcanization accelerators and vulcanization agents) have been proposed to improve the heat resistance of the above diene-based rubber. For example, a diene rubber composition (patent document 1) has been proposed in which, as the blending ratio of the anti-aging agents, the amount of an amine-based anti-aging agent is set to be within the range of 0.5 to 3 moles relative to 1 mole of a benzimidazole group of a benzimidazole-based anti-aging agent and the total amount of the anti-aging agents is set to be within the range of 1 to 10 parts by weight relative to 100 parts by weight of a rubber component. In addition, an anti-vibration rubber composition (patent document 2) blended with natural rubber and butadiene rubber containing a specified amount of 2-mercaptobenzimidazole zinc salt and 4,4′-bis(α, α-dimethylbenzyl)diphenylamine and an anti-vibration rubber composition (patent document 3) containing a compound having a terminal carbon-carbon double bond and a carbonyl group at the α-position thereof and an imidazole-based anti-aging agent have also been proposed.

There has been known a technique to improve heat resistance by crosslinking (vulcanization) with sulfur donor compounds (sulfur donors), such as tetramethylthiuram disulfide (TMTD) and 4,4′-dithiodimorpholine with or without a small amount of sulfur, as vulcanizing system (vulcanization accelerator and vulcanizing agent).

### PRIOR ART REFERENCE(S)

### Patent Document(s)

[Patent Document 1]: Japanese Patent Application Publication No. 2002-194140
[Patent Document 2]: Japanese Patent Application Publication No. H11-116733
[Patent Document 3]: Japanese Patent Application Publication No. 2015-025060

### SUMMARY OF THE INVENTION

### Problem to be Solved by the Invention

As proposed above, although it is well known that butadiene rubber is contained in a rubber component to obtain desired anti-vibration properties (for example, low dynamic magnification), when an anti-aging agent is contained, the dynamic magnification usually increases, and, depending on the type and amount of the anti-aging agent to be used, it may be difficult to achieve the desired balance between anti-vibration properties and heat resistance/heat settling resistance.

For example, in the patent document 1, there has been described that, in order to achieve the both of the heat resistance and low dynamic magnification, a rubber component containing terminal-modified butadiene rubber is used, 2-mercaptobenzimidazole zinc salt is used as an imidazole-based anti-aging agent, and N,N′-Di-β-naphthyl-p-phenylenediamine is used as an amine-based anti-aging agent. There has also been described that, as a ratio of the anti-aging agents, the amount of the amine-based anti-aging agent is set to be within the range of 0.5 to 3 moles relative to 1 mole of a benzimidazole group in the benzimidazole-based anti-aging agent.

Here, 2-mercaptobenzimidazole zinc salt is a compound having two imidazole groups per molecule and a molecular weight of 397.85, which is represented by the following general formula.

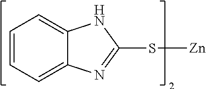

N,N′-Di-β-naphthyl-p-phenylenediamine is a compound having a molecular weight of 360.45 which is represented by the following general formula.

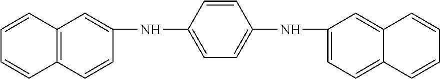

In addition, in case of the patent document 1, since 0.5 to 3 moles of the amine-based anti-aging agent is blend relative to 1 mole of the benzimidazole group of the benzimidazole-based anti-aging agent, the amount of N,N′-Di-β-naphthyl-p-phenylenediamine relative to 1 part by mass of 2-mercaptobenzimidazole zinc salt (2 moles of imidazole group) is within the range of [0.5×360.45/(397.85/2)=]0.906 parts by mass to [3×360.45/(397.85/2)=]5.436 parts by mass. In other words, relative to 1 part by mass of N,N′-Di-β-naphthyl-p-phenylenediamine, 2-mercaptobenzimidazole zinc salt (2 moles of imidazole group) is added within the range of 0.184 to 1.104 parts by mass.

However, according to the detailed examination by the present inventors, N,N′-Di-β-naphthyl-p-phenylenediamine increases the dynamic magnification when contained above a certain amount in the anti-vibration rubber composition. Therefore, further improvement may be necessary to achieve both heat resistance and anti-vibration properties (dynamic magnification). In addition, the patent document 1 fails to disclose or suggest any effect on the improvement of heat resistance when the content of N,N′-Di-β-naphthyl-p-phenylenediamine is set relatively low (for example, 1 part by mass or less) and when the content of 2-mercaptobenzimidazole zinc salt is set relatively high (for example, 1 part by mass or more).

In the patent document 2, there has been described that, in order to improve the low dynamic magnification and settling resistance, a rubber composition contains butadiene rubber in which the content of a cis-1,4 bond is 97% or more and 4,4′-bis(α,α-dimethylbenzyl)diphenylamine and zinc salt of 2-mercaptobenzimidazole or its methylated derivative as an anti-aging agent are contained to improve heat resistance.

However, according to the detailed examination by the present inventors, 4,4′-bis(α,α-dimethylbenzyl)diphenylamine increases the dynamic magnification when contained above a certain amount in the anti-vibration rubber composition, and depending on the amount of each content, there is case where long-term heat resistance is insufficient.

In the patent document 3, there is described an anti-vibration rubber composition containing a compound having a carbonyl group at the α-position and an imidazole-based anti-aging agent to diene-based rubber.

However, according to the examination by the present inventors, although a compound having a carbonyl group at the α-position can greatly contribute to damping properties as described in the patent document 3, there is case where when being added to an anti-vibration rubber composition, the vulcanization rate tends to be accelerated, resulting in a significant decrease in scorch stability (shorter scorch time). In addition, there is case where scorch (premature vulcanization) occurs during storage of the anti-vibration rubber composition or case where vulcanization progresses during injection molding, and then molding becomes difficult. Furthermore, although the compound having a carbonyl group at the α-position can greatly contribute to the improvement of damping properties as described in the patent document 3, the dynamic magnification increases significantly, and thus low dynamic magnification may become insufficient.

The present invention was made in consideration of such a problem, and an object of the present invention is to provide a technique that can contribute to easily achieve anti-vibration characteristics and heat resistance and heat settling resistance as desired.

### Means for Solving Problem

The present inventor has made an eager study to obtain an anti-vibration rubber composition that achieves the above-mentioned object.

As a result, it has been found that, in an anti-vibration rubber composition having natural rubber (NR) and/or isoprene rubber (IR) and butadiene rubber (BR) as main rubber components with excellent low dynamic magnification and durability, when the total rubber component is set as 100 parts by mass, 1.8 to 5 parts by mass of 2-mercaptobenzimidazole zinc salt, 0.2 to 1.1 parts by mass of N,N′-Di-2-naphthyl-p-phenylenediamine, 0.2 to 0.7 parts by mass of sulfur as a vulcanizing agent and a specified amount of a specific sulfur donor (sulfur donor) compound are contained, and thereby an anti-vibration rubber composition and anti-vibration rubber that achieve the above object can be obtained, and then the present invention has been completed.

As one aspect of an anti-vibration rubber composition and anti-vibration rubber of the present invention, the followings [1] to [4] can be cited.

[1] In an anti-vibration rubber composition having natural rubber (NR) and/or isoprene rubber (IR) and butadiene rubber (BR) as main rubber components, when the total rubber component is set as 100 parts by mass, an anti-vibration rubber composition is characterized by containing 1.8 to 5 parts by mass of 2-mercaptobenzimidazole zinc salt, 0.2 to 1.1 parts by mass of N,N′-Di-2-naphthyl-p-phenylenediamine, 0.2 to 0.7 parts by mass of sulfur and 2 to 7 parts by mass of tetrakis(2-ethylhexyl)thiuram disulfide.

[2] In an anti-vibration rubber composition having natural rubber (NR) and/or isoprene rubber (IR) and butadiene rubber (BR) as main rubber components, when the total rubber component is set as 100 parts by mass, the anti-vibration rubber composition is characterized by containing 1.8 to 5 parts by mass of 2-mercaptobenzimidazole zinc salt, 0.2 to 1.1 parts by mass of N,N′-Di-2-naphthyl-p-phenylenediamine, 0.2 to 0.7 parts by mass of sulfur, and 1 to 3 parts by mass of 2-(4-morpholinodithio)benzothiazole.

[3] In the [1] or [2], the anti-vibration rubber composition is preferable that the main rubber components are a blend of natural rubber (NR) and butadiene rubber (BR) with an NR/BR ratio of 90/10 to 60/40 in the ratio of natural rubber (NR) to butadiene rubber (BR), and the butadiene rubber has a Mooney viscosity (ML₁₊₄) of 50-75 at 100° C.

[4] The anti-vibration rubber is characterized in that the anti-vibration rubber composition according to any of the [1] to [3] is vulcanized and bonded to the surface of a metal fitting via an adhesive layer formed on the surface of the metal fitting, such that the metal fitting and the vulcanized rubber with the anti-vibration rubber composition are integrally formed.

### Effects of the Invention

According to the present invention, it is possible to contribute to easily achieve anti-vibration characteristics and heat resistance and heat settling resistance as desired.

### BRIEF DESCRIPTION OF THE DRAWINGS

FIG. 1 is a schematic illustrative view of a test piece formed by using each of anti-vibration rubber compositions of examples 1 to 13 and comparative examples 1 to 15.

### MODE FOR IMPLEMENTING THE INVENTION

In the following, matters relevant to the implementation of the present invention will be explained in detail.

As mentioned above, the anti-vibration rubber composition of the present invention is one containing 1.8 to 5 parts by mass of 2-mercaptobenzimidazole zinc salt, 0.2 to 1.1 parts by mass of N,N′-Di-2-naphthyl-p-phenylenediamine, 0.2 to 0.7 parts by mass of sulfur and 2 to 7 parts by mass of tetrakis(2-ethylhexyl)thiuram disulfide when the total rubber component is set as 100 parts by mass, in an anti-vibration rubber composition having natural rubber (NR) and/or isoprene rubber (IR) and butadiene rubber (BR) as main rubber components.

According to such a configuration, it is possible to provide an anti-vibration rubber composition for manufacturing anti-vibration rubber having desired heat resistance (heat aging resistance) and heat settling resistance and the like while suppressing an increase in dynamic magnification.

In addition, the anti-vibration rubber composition may contains 2-(4-morpholinodithio)benzothiazole (1 to 3 parts by mass) instead of tetrakis(2-ethylhexyl)thiuram disulfide as the sulfur donor compound, and consequently, it is possible to provide an anti-vibration rubber composition for manufacturing anti-vibration rubber that has desired heat resistance, heat settling resistance and the like and also has a small change in vibration characteristics (spring constant) while suppressing an increase in dynamic magnification, even when exposed to a thermal environment for a long period of time.

In addition, the anti-vibration rubber composition may be vulcanized and bonded to the surface of a metal fitting via an adhesive layer provided on the surface of the metal fitting, and with this, it is possible to provide anti-vibration rubber with excellent heat-resistant adhesion, in which the metal fitting and the vulcanized rubber with the anti-vibration rubber composition are integrally formed.

Next, each component applicable to the anti-vibration rubber composition and anti-vibration rubber (rubber molded product) of the present embodiment will be explained. In addition, hereafter, when indicating the content of all components (materials), it may be simply stated as parts by mass, meaning that it is the parts by mass of a component when the total rubber component is set as 100 parts by mass.

### [Rubber Component]

In the anti-vibration rubber composition according to the present embodiment, natural rubber (NR) and/or isoprene rubber (IR) and butadiene rubber (BR) are used as main rubber components in a rubber component. This main rubber components mean that the total amount of natural rubber (NR) and/or isoprene rubber (IR) and butadiene rubber (BR) is 90 mass % or more of the total rubber component.

In the rubber component, it is preferable to include natural rubber, for example, from the viewpoint of stability of rubber strength and durability of anti-vibration rubber. As natural rubber, there is no particular limitation, and for example, ordinary natural rubber used for anti-vibration rubber can be applied. Specifically, for example, for sheet rubber (including crepes), there can be cited RSS (RIBBED SMOKED SHEET), WHITE CREPES, PALE CREPES, ESTATE BROWN CREPES, COMP CREPES, THIN BROWN CRAPES (RIMILLS), THICH BLANCKET CRAPES (AMBERS), FLAT BARK CREPES, and all grades of PURE SMOKED BRANKET CRAPES. In addition, in block rubber, there can be cited SMR (STANDARD MALAYSIAN RUBBER), SIR (STANDARD INDONESIAN RUBBER), STR (STANDARD THAI RUBBER), SSR (STANDARD SINGAPOREAN RUBBER), SCR (STANDARD CEYLON RUBBER), SVR (STANDARD VIETNAMESE RUBBER) and the like.

In addition, it is preferable that the rubber component contains butadiene rubber (BR) from the viewpoint of low dynamic magnification and durability. That is, a diene-based rubber in which natural rubber (NR) and butadiene rubber (BR) are blended is preferable. The blending ratio of natural rubber (NR) to butadiene rubber (BR) can be set as desired, and one example thereof is to set the natural rubber (NR)/butadiene rubber (BR) ratio within the range of 90/10 to 50/50 (mass ratio), preferably 90/10 to 60/40. In such a ratio, it is possible to obtain an anti-vibration rubber having excellent durability and low dynamic magnification. In case of natural rubber (NR)/butadiene rubber (BR), as the ratio of natural rubber (NR) increases, the vulcanized rubber strength is higher and more stable, and the durability variation is reduced. On the other hand, as the ratio of butadiene rubber (BR) increases, it becomes easier to obtain an anti-vibration rubber composition having lower dynamic magnification.

There is no particular limitation on butadiene rubber (BR) that can be applied in the present embodiment, and, for example, ordinary butadiene rubber used for anti-vibration rubber can be applied. When durability against repeated deformation is important, the higher the amount of cis 1,4-bonds, the more desirable, and as one example, butadiene rubber (high cis BR) in which the amount of cis 1,4-bonds is 90% or more is cited as a preferable one, and high cis BR in which the amount of cis 1,4-bonds is 93% or more is cited as a more preferable one.

In addition, in butadiene rubber (BR) having the same chemical composition, since there is tendency that the higher Mooney viscosity (ML₁₊₄) is, the higher the molecular weight and durability becomes higher, it is preferable to apply one having, for example, a Mooney viscosity (ML₁₊₄) of 50 or higher at 100° C. On the other hand, as Mooney viscosity (ML₁₊₄) increases, the fluidity of rubber tends to decrease, and when Mooney viscosity (ML₁₊₄) is too high, the kneading processability and moldability of the rubber material composition may easily decrease. Therefore, it is preferable to apply one having a Mooney viscosity (ML₁₊₄) of 75 or less at 100° C., and more preferably, one having a Mooney viscosity (ML₁₊₄) of 65 or less.

As a specific example of such a butadiene rubber, for example, there can be cited BR730, BR54, BR740 (made by ENEOS Materials, respectively), Uvepol 390L (made by Ube Industries, Ltd.), BUNA CB21, CB22, CB1221 (made by Aranseo, respectively). On the other hand, when lower dynamic magnification is required, for example, end-modified butadiene rubber with the end modified with an N-methylpyrrolidone group (for example, Nipol 1250H made by ZEON Corporation) is suitable for use.

Isoprene rubber (IR) has performance similarly to that of natural rubber (NR), has fewer impurities such as foreign matter, and has usually a potential substitute for natural rubber (NR). On the other hand, from the viewpoint of stability of rubber strength and durability, natural rubber (NR) is usually has better results and can be preferably used.

In addition, there is no particular problem if other rubber components other than diene rubber, such as styrene butadiene rubber (SBR) and EPDM, are contained as needed (for example, a small amount within the range of 10 parts by mass or less) for the purpose of improving processability and the like.

### [Anti-Aging Agent]

An anti-vibration rubber composition used in the rubber molding in the present embodiment contains, as anti-aging agents, 2-mercaptobenzimidazole zinc salt and N,N′-Di-2-naphthyl-p-phenylenediamine as essential components.

2-mercaptobenzimidazole zinc salt is known as a secondary anti-aging agent and is generally used in combination with various amine and phenolic anti-aging agents, which are primary anti-aging agents, in 1 part by mass or less in general.

On the other hand, in the present embodiment, 2-mercaptobenzimidazole zinc salt is contained within the range of 1.8 to 5 parts by mass. If the content of 2-mercaptobenzimidazole zinc salt is less than 1.8 parts by mass, the effect of improving heat resistance over a long period of time may not be obtained. On the other hand, if the content of 2-mercaptobenzimidazole zinc salt is 5 parts by mass or more, further improvement in heat resistance cannot be obtained, and the compression set resistance rate tends to increase. A more preferable content of 2-mercaptobenzimidazole zinc salt is within the range of 1.9 to 4 parts by mass.

As benzimidazole-based anti-aging agents, which are similar anti-aging agents, 2-mercaptobenzimidazole and 2-mercaptomethylbenzimidazole are known. However, as shown in the present embodiment, in an anti-vibration rubber composition that has natural rubber (NR) and/or isoprene rubber (IR) and butadiene rubber (BR) as main rubber components and contains 0.2 to 0.7 parts by mass of sulfur as a vulcanizing agent and a vulcanization accelerator that serves as a sulfur donor (sulfur donor), the 2-mercaptobenzimidazole is less effective in improving long-term heat resistance as compared with 2-mercaptobenzimidazole zinc salt, and may increase the compression set resistance rate. In addition, although, similar to the 2-mercaptobenzimidazole zinc salt, the 2-mercaptomethylbenzimidazole may provide a significant improvement in terms of heat resistance, the compression set resistance rate tends to increase, and it is not preferable as anti-vibration rubber.

In the anti-vibration rubber composition used for the rubber molding of the present embodiment, as an amine-based anti-aging agent, 0.2 to 1.1 parts by mass of N,N′-Di-2-naphthyl-p-phenylenediamine is contained. This N,N′-Di-2-naphthyl-p-phenylenediamine is known to have low volatility by heating and remain in vulcanized rubber for a long period of time, and it is preferable for use in terms of long-term heat resistance. In addition, when the N,N′-Di-2-naphthyl-p-phenylenediamine and 2-mercaptobenzimidazole zinc salt are used together, by the combined effect, sufficient long-term heat resistance improvement can be obtained even if the content of the N,N′-Di-2-naphthyl-p-phenylenediamine is small.

On the other hand, if the content of N,N′-Di-2-naphthyl-p-phenylenediamine is too high, the dynamic magnification of anti-vibration rubber may increase, and when 2-mercaptobenzimidazole zinc salt is used in combination (1.8 to 5 parts by mass) as mentioned above, even if the content of N,N′-Di-2-naphthyl-p-phenylenediamine exceeds 1.1 parts by mass, further improvement of heat resistance cannot be obtained.

In addition, in most cases, in the anti-vibration rubber made from an anti-vibration rubber composition simply containing an amine-based anti-aging agent in the blending ratio shown in the patent document 1, dynamic magnification tends to increase, and in many cases, the improvement in heat resistance under long-term thermal environments (for example, thermal exposure at 100° C. for 500 hours or more) is not sufficient.

In addition, as shown in the patent document 3, an anti-aging agent having a carbonyl group at the α-position is known as a reactive anti-aging agent, and has excellent long-term heat resistance. However, the anti-vibration rubber made from an anti-vibration rubber composition containing such an anti-aging agent having a carbonyl group at the α-position easily increases in dynamic magnification, and it is not preferable. Furthermore, since compression set resistance tends to be reduced, it is not preferable to contain it in present embodiment.

In addition, it is known that diene-based rubber has poor ozone resistance. It is therefore preferable to contain, for example, N-phenyl-N′-(1,3-dimethylbutyl)-p-phenylenediamine and/or N-phenyl-N′-isopropyl-p-phenylenediamine (for example, containing between 2 and 5 parts by mass), when the purpose is to provide ozone resistance.

### [Sulfur and Sulfur Donor Compounds (Sulfur Donors)]

The anti-vibration rubber composition of the present embodiment contains sulfur as a vulcanizing agent within the range of 0.2 to 0.7 parts by mass (preferably 0.3 to 0.6 parts by mass) and a specific amount of a specific sulfur donor (sulfur donor) compound.

Here, although some vulcanization accelerators are known to have both a vulcanization accelerator effect and a sulfur donor (cross-linking agent) effect on low sulfur (low sulfur content) rubber compositions, and there are some compounds that are classified as vulcanization accelerators, in the explanation according to the present embodiment, they may be referred to as sulfur donor compounds.

In general, although as a technique to improve the heat resistance of rubber compositions, a method of cross-linking (vulcanization) with sulfur donor compounds such as tetramethylthiuram disulfide (TMTD) without containing sulfur (sulfur-free vulcanization method) is known, according to the detailed examination by the present inventors, it has been found that the rubber composites obtained by the sulfur-free vulcanization method usually do not keep sufficient heat resistance in terms of long-term heat resistance. The reason for this is probably that the rubber compositions vulcanized by the sulfur-free vulcanization method, even if it has reached a heat-resistant crosslinked mode as a crosslinked mode, have a large amount of unreacted components and reaction residues derived from sulfur donor compounds, resulting in a decrease in long-term heat resistance.

On the other hand, by containing a small amount of sulfur (0.2-0.7 parts by mass), as in the anti-vibration rubber composition of the present embodiment, the amount of reaction and unreacted residues derived from sulfur donor compounds can be reduced, and thus improvement in the long-term heat resistance may be achieved.

Although the sulfur used in the present embodiment is not particularly limited, for example, one known as a compounding material for rubber can be cited. Specifically, powdered sulfur, precipitated sulfur, surface-treated powdered or precipitated sulfur, and insoluble sulfur can be cited.

As a sulfur donor compound, tetrakis(2-ethylhexyl)thiuram disulfide, tetrabenzylthiuram disulfide, 2-(4′-morpholinodithio) benzothiazole, 4,4′-dithiodimorpholine, tetramethylthiuram disulfide, tetraethylthiuram disulfide, tetrabutylthiuram disulfide, dipentamethylenthiuram tetrasulfide and the like can be used. Among these, tetrakis(2-ethylhexyl)thiuram disulfide, tetrabenzylthiuram disulfide, and 2-(4′-morpholinodithio)benzothiazole are preferably used. In particular, in terms of heat resistance, compression set resistance rate and thermal adhesion resistance, tetrakis(2-ethylhexyl)thiuram disulfide is used more preferably. The content of tetrakis(2-ethylhexyl)thiuram disulfide is set within the range of 2 to 7 parts by mass.

When tetrakis(2-ethylhexyl)thiuram disulfide is used, it tends to have better long-term heat resistance than when other thiuram-based sulfur donor compounds are used. This reason is probably that because the reaction activity of unreacted components and reaction residues derived from the sulfur donor compounds is kept low, and unnecessary reactions are less likely to occur even if the anti-vibration rubber composition is exposed under a thermal environment for a long period of time.

Here, the general mechanism of thermal deterioration of rubber is usually explained by autoxidation (deterioration due to high-temperature autoxidation), which occurs in the presence of oxygen in the air. In the case of anti-vibration rubber, it is extremely important to suppress the deterioration of an exposed surface (hereinafter referred to simply as “exposed part”) of rubber.

However, in case of anti-vibration rubber such as a rubber bushing that has a part covered by metal (hereinafter referred to simply as “non-exposed part”) and a thick part (for example, a part with a rubber thickness of 4 mm or more), the changes in characteristics of each of the rubber in the non-exposed part and the rubber inside the thick part affect vibration characteristics, even if they are not exposed to the air. Consequently, in case of general anti-vibration rubber, there has been a risk that the rubber in the exposed part would be oxidative deterioration and surface hardening easily due to long-term thermal aging.

Therefore, in the anti-vibration rubber of the present embodiment, when an object is set to achieve smaller changes in vibration characteristics due to long-term thermal exposure, 2-(4′-morpholinodithio)benzothiazole is used as a sulfur donor compound. According to the anti-vibration rubber composition using 2-(4′-morpholinodithio)benzothiazole as a sulfur donor compound in this way, the hardness change of the rubber in the interior part of the anti-vibration rubber is small, and by the balance between the degree of hardening of the rubber surface in the exposed and unexposed parts and the small change in hardness of the rubber in the inside (for example, inside the thick part), vibration characteristic changes can be suppressed.

In the anti-vibration rubber composition of the present embodiment, the content of 2-(4-morpholinodithio)benzothiazole is within the range of 1 to 3 parts by mass, preferably 1.2 to 3 parts by mass. If the content of 2-(4-morpholinodithio)benzothiazole exceeds 3 parts by mass, heat resistance adhesion may decrease, which is not desirable.

In addition, as a vulcanizing agent, m-phenylenediamaleimide can also be used together with sulfur and a sulfur donor compound.

### [Vulcanization Accelerator]

In addition, it is preferable that the anti-vibration rubber composition of the present embodiment is combined with a known vulcanization accelerator, which is used, for example, as a compounding material for sulfur vulcanized rubber, as appropriate. The vulcanization accelerator is not limited, and specifically, there can be cited sulfonamide compounds such as N-cyclohexyl-2-benzothiazole sulfenamide, N-oxydiethylene-2-benzothiazole sulfonamide, and N,N-diisopropyl-2-benzothiazole sulfonamide, thiazole compounds such as 2-mercaptobenzothiazole, 2,2′-dibenzothiazolyl disulfide, zinc salt of 2-mercaptobenzothiazole and cyclohexylamine salts of 2-mercaptobenzothiazole, guanidine compounds such as diphenylguanidine, triphenylguanidine, diorsonitrile guanidine, orthonitrile baiguanide and diphenylguanidine phthalate, and thiuram compounds such as tetramethylthiuram monosulfide.

Furthermore, for the purpose of adjusting vulcanization speed and delaying scorch time, anti-scorch agents such as N-cyclohexylthio phthalimide and N-phenyl-N-(trichloromethylthio) benzenesulfonamide can be preferably used.

### [Carbon Black]

The anti-vibration rubber composition of the present embodiment can use carbon black as appropriate, and one example of which is the use of known carbon black, but it is particularly not limited. Specifically, FT, SRF, GPF, FEF, MAF, HAF, ISAF, and SAF grades of carbon blacks can be cited. Among these, FEF-grade, MAF-grade, and HAF-grade carbon blacks are preferably used because of good balance of rubber strength, durability, and low dynamic magnification. In addition, for example, SRF-HS grade carbon black, which is SRF grade and well-structured, is preferably used in terms of support performance and low dynamic magnification for automotive vehicles.

### [Filler]

The anti-vibration rubber composition of the present embodiment may contain a filler for the purpose of adjusting hardness and improving processability. For example, fillers normally used in rubber compositions, such as silica such as wet silica, dry silica and colloidal silica, calcium carbonate, clay, talc may be used as needed. These fillers can be used alone or in combination with two or more fillers.

### [Process Oil]

The anti-vibration rubber composition of the present embodiment may contain process oil for the purpose of adjusting hardness and improving processability. As examples of the process oil, naphthenic oil, paraffinic oil and aromatic oil can be cited. These process oils can be used alone or in combination with two or more process oils. Although the content of the process oil can be set as desired, for example, it is preferable to set the content within the range of 0 to 20 parts by mass. If the content of the process oil exceeds 20 parts by mass, long-term heat resistance may decrease, which is not preferable.

### [Vulcanizing Aid]

It is preferable for the anti-vibration rubber composition of the present embodiment to contain a vulcanization aid of zinc oxide (ZnO) or composite zinc oxide as appropriate, and, in addition, it is preferable to contain it together with other vulcanization aids (for example, stearic acid, zinc stearate) as appropriate.

Here, in composite zinc oxide, one having a layer of zinc oxide (zinc oxide) on the surface and an inorganic metal salt inside as a core component is known, and as one example thereof, META-Z L series (META-Z L4, L50, L60) made by Inoue Lime Industries, Inc. can be cited.

Although the content of zinc oxide or composite zinc oxide can be properly set, for example, it is preferably set between 3 and 15 parts by mass relative to 100 parts by mass of rubber component.

Although the content of stearic acid or zinc stearate can be properly set as desired, for example, it is preferably set to be 0.1 to 2 parts by mass relative to 100 parts by mass of rubber component.

### [Processing Aid]

The anti-vibration rubber composition of the present embodiment can contain a processing aid for the purpose of improving processability. As a processing aid, a compound normally used in the processing of rubber can be properly applied. As one example thereof, various additives such as lubricants, adhesive agents, dispersants, compatibilizers and homogenizers can be cited.

### [Method of Preparing Anti-Vibration Rubber Composition]

The anti-vibration rubber composition of the present embodiment can be prepared by kneading the above-mentioned rubber component, anti-aging agent component, and vulcanizing agent component (and other materials cited above as necessary), which are essential components, using a kneader such as a pressure kneader, Banbury mixer, intermix mixer and open roll.

The anti-vibration rubber of the present embodiment is obtained by vulcanizing the anti-vibration rubber composition mentioned above. The anti-vibration rubber composition becomes an elastic body for anti-vibration rubber by being appropriately vulcanized (for example, at a vulcanization temperature of 145 to 170° C. for 3 to 30 minutes).

That is, anti-vibration rubber consisting of an elastic body obtained by vulcanizing the anti-vibration rubber composition of the present embodiment has excellent long-term heat resistance, a low compression set rate, and a low dynamic magnification, resulting in excellent vibration isolation properties. Consequently, it is suitable for use as anti-vibration rubber which is required to withstand severe thermal environments and have vibration isolation performance from vibration sources, in vehicles such as automobiles and various types of machinery.

### EXAMPLE

In the following, although Examples (Examples 1 to 13) of the present embodiment will be shown, the present invention is not limited to the Examples.

### <<Preparation of Anti-Vibration Rubber Composition>>

Anti-vibration rubber compositions of Examples 1-13 and Comparative Examples 1-15 were prepared by blending and kneading various materials in the ratio shown in Tables 1 to 4. In addition, for the kneading mentioned above, materials other than the vulcanizing agent, the sulfur donor compound and vulcanization accelerator were first kneaded for 5 minutes using a Banbury mixer to obtain kneaded materials. Next, in the kneaded materials, anti-vibration rubber compositions were prepared by adding the vulcanizing agent, sulfur donor compound and vulcanization accelerator and kneading them for 5 minutes while cooling using an open roll (cooling at a cooling water temperature in the open roll set to approximately 2000).

TABLE 1
(parts by mass)

| | | Anti-vibration rubber composition | | | | | | | |
|---|---|---|---|---|---|---|---|---|---|
| | | Example 1 | Example 2 | Example 3 | Example 4 | Example 5 | Example 6 | Example 7 | Example 8 |
| Compounding | Natural rubber | 70 | 70 | 70 | 70 | 70 | 70 | 70 | 70 |
| material | Butadiene | 30 | 30 | 30 | 30 | 30 | 30 | | |
| | rubber -1 | | | | | | | | |
| | Butadiene | | | | | | | 30 | |
| | rubber -2 | | | | | | | | |
| | Butadiene | | | | | | | | 30 |
| | rubber -3 | | | | | | | | |
| | Composite | 5 | 5 | 5 | 5 | 5 | 5 | 5 | 5 |
| | zinc oxide | | | | | | | | |
| | Stearic acid | 1 | 1 | 1 | 1 | 1 | 1 | 1 | 1 |
| | Anti-aging | 0.8 | 0.5 | 0.3 | 1 | 0.8 | 0.8 | 0.8 | 0.8 |
| | agent -1 | | | | | | | | |
| | Anti-aging | 2.2 | 2 | 4.5 | 4.5 | 2.2 | 2.2 | 2.2 | 2.2 |
| | agent -2 | | | | | | | | |
| | Anti-aging | 2 | 2 | 2 | 2 | 2 | 2 | 2 | 2 |
| | agent -3 | | | | | | | | |
| | Paraffin wax | 1.5 | 1.5 | 1.5 | 1.5 | 1.5 | 1.5 | 1.5 | 1.5 |
| | Carbon | 30 | 30 | 30 | 30 | 30 | 30 | 30 | 0 |
| | black -1 | | | | | | | | |
| | Carbon | 0 | 0 | 0 | 0 | 0 | 0 | 0 | 35 |
| | black -2 | | | | | | | | |
| | Process oil | 0 | 0 | 0 | 0 | 0 | 0 | 0 | 0 |
| | Sulfur | 0.4 | 0.4 | 0.4 | 0.4 | 0.4 | 0.3 | 0.4 | 0.4 |
| | Sulfur donor | 2.5 | 2.5 | 2.5 | 2.5 | 4.0 | 6.0 | 2.5 | 2.5 |
| | compound -1 | | | | | | | | |
| | Sulfur donor | | | | | | | | |
| | compound -2 | | | | | | | | |
| | Sulfur donor | | | | | | | | |
| | compound -3 | | | | | | | | |
| | Vulcanization | 3.0 | 3.0 | 3.0 | 3.0 | 3.0 | 3.0 | 3.0 | 3.0 |
| | accelerator -1 | | | | | | | | |
| | Vulcanization | | | | | | | | |
| | accelerator -2 | | | | | | | | |

TABLE 2
(parts by mass)

| | | Anti-vibration rubber composition | | | | |
|---|---|---|---|---|---|---|
| | | Example 9 | Example 10 | Example 11 | Example 12 | Example 13 |
| Compounding | Natural rubber | 70 | 70 | 70 | 70 | 70 |
| material | Butadiene | 30 | 30 | 30 | 30 | 30 |
| | rubber -1 | | | | | |
| | Butadiene | | | | | |
| | rubber -2 | | | | | |
| | Butadiene | | | | | |
| | rubber -3 | | | | | |
| | Composite | 5 | 5 | 5 | 5 | 5 |
| | zinc oxide | | | | | |
| | Stearic acid | 1 | 1 | 1 | 1 | 1 |
| | Anti-aging | 0.8 | 0.8 | 0.5 | 0.8 | 0.8 |
| | agent -1 | | | | | |
| | Anti-aging | 2.2 | 2.2 | 3.5 | 2.2 | 2.2 |
| | agent -2 | | | | | |
| | Anti-aging | 2 | 2 | 2 | 2 | 2 |
| | agent -3 | | | | | |
| | Paraffin wax | 1.5 | 1.5 | 1.5 | 1.5 | 1.5 |
| | Carbon | 30 | 30 | 30 | 30 | 30 |
| | black -1 | | | | | |
| | Carbon | 0 | 0 | 0 | 0 | 0 |
| | black -2 | | | | | |
| | Process oil | 0 | 0 | 0 | 0 | 0 |
| | Sulfur | 0.5 | 0.5 | 0.5 | 0.4 | 0.5 |
| | Sulfur donor | | | | | |
| | compound -1 | | | | | |
| | Sulfur donor | 2.0 | 2.0 | 2.0 | 3.0 | 1.3 |
| | compound -2 | | | | | |
| | Sulfur donor | | 0.3 | | | 0.4 |
| | compound -3 | | | | | |
| | Sulfur donor | | | | | |
| | compound -4 | | | | | |
| | Vulcanization | 2.0 | 2.0 | 2.0 | 1.0 | 2.5 |
| | accelerator -1 | | | | | |
| | Vulcanization | 0.3 | | 0.3 | 0.3 | |
| | accelerator -2 | | | | | |

TABLE 3
(parts by mass)

| | | Anti-vibration rubber composition | | | | | | | |
|---|---|---|---|---|---|---|---|---|---|
| | | Comparative | Comparative | Comparative | Comparative | Comparative | Comparative | Comparative | Comparative |
| | | Example 1 | Example 2 | Example 3 | Example 4 | Example 5 | Example 6 | Example 7 | Example 8 |
| Compounding | Natural | 70 | 70 | 70 | 70 | 70 | 70 | 70 | 70 |
| material | rubber | | | | | | | | |
| | Butadiene | 30 | 30 | 30 | 30 | 30 | 30 | 30 | 30 |
| | rubber -1 | | | | | | | | |
| | Butadiene | | | | | | | | |
| | rubber -2 | | | | | | | | |
| | Butadiene | | | | | | | | |
| | rubber -3 | | | | | | | | |
| | Composite | 5 | 5 | 5 | 5 | 5 | 5 | 5 | 5 |
| | zinc oxide | | | | | | | | |
| | Stearic acid | 1 | 1 | 1 | 1 | 1 | 1 | 1 | 1 |
| | Anti-aging | 0.8 | 0 | 3 | 0 | 4 | 3 | 0.8 | 0 |
| | agent -1 | | | | | | | | |
| | Anti-aging | 2.2 | 0 | 0.8 | 0 | 0 | 0 | 0 | 0 |
| | agent -2 | | | | | | | | |
| | Anti-aging | 2 | 2 | 2 | 2 | 2 | 2 | 2 | 2 |
| | agent -3 | | | | | | | | |
| | Anti-aging | | | | 5 | | 0.8 | | 1 |
| | agent -4 | | | | | | | | |
| | Anti-aging | | | | | | | 2.2 | |
| | agent -5 | | | | | | | | |
| | Anti-aging | | | | | | | | 4 |
| | agent -6 | | | | | | | | |
| | Paraffin wax | 1.5 | 1.5 | 1.5 | 1.5 | 1.5 | 1.5 | 1.5 | 1.5 |
| | Carbon | 30 | 30 | 30 | 30 | 30 | 30 | 30 | 30 |
| | black -1 | | | | | | | | |
| | Carbon | 0 | 0 | 0 | 0 | 0 | 0 | 0 | 0 |
| | black -2 | | | | | | | | |
| | Process oil | 0 | 0 | 0 | 0 | 0 | 0 | 0 | 0 |
| | Sulfur | 0.5 | 0.4 | 0.4 | 0.4 | 0.4 | 0.4 | 0.4 | 0.4 |
| | Sulfur donor | | 2.5 | 2.5 | 2.5 | 2.5 | 2.5 | 2.5 | 2.5 |
| | compound -1 | | | | | | | | |
| | Sulfur donor | | | | | | | | |
| | compound -2 | | | | | | | | |
| | Sulfur donor | 1.2 | | | | | | | |
| | compound -3 | | | | | | | | |
| | Vulcanization | 1.5 | 3.0 | 3.0 | 3.0 | 3.0 | 3.0 | 3.0 | 3.0 |
| | accelerator -1 | | | | | | | | |
| | Vulcanization | | | | | | | | |
| | accelerator -2 | | | | | | | | |

TABLE 4
(parts by mass)

| | | Anti-vibration rubber composition | | | | | | |
|---|---|---|---|---|---|---|---|---|
| | | Comparative | Comparative | Comparative | Comparative | Comparative | Comparative | Comparative |
| | | Example 9 | Example 10 | Example 11 | Example 12 | Example 13 | Example 14 | Example 15 |
| Compounding | Natural rubber | 70 | 70 | 70 | 70 | 70 | 70 | 70 |
| material | Butadiene | 30 | 30 | 30 | 30 | 30 | 30 | 30 |
| | rubber -1 | | | | | | | |
| | Butadiene | | | | | | | |
| | rubber -2 | | | | | | | |
| | Butadiene | | | | | | | |
| | rubber -3 | | | | | | | |
| | Composite | 5 | 5 | 5 | 5 | 5 | 5 | 5 |
| | zinc oxide | | | | | | | |
| | Stearic acid | 1 | 1 | 1 | 1 | 1 | 1 | 1 |
| | Anti-aging | 0 | 0.8 | 3 | 0.8 | 0 | 0.8 | 0.8 |
| | agent -1 | | | | | | | |
| | Anti-aging | 0 | 2.2 | 0.5 | 2.2 | 4 | 2.2 | 2.2 |
| | agent -2 | | | | | | | |
| | Anti-aging | 2 | 2 | 2 | 2 | 2 | 2 | 2 |
| | agent -3 | | | | | | | |
| | Paraffin wax | 1.5 | 1.5 | 1.5 | 1.5 | 1.5 | 1.5 | 1.5 |
| | Carbon | 30 | 30 | 30 | 30 | 30 | 30 | 30 |
| | black -1 | | | | | | | |
| | Carbon | 0 | 0 | 0 | 0 | 0 | 0 | 0 |
| | black -2 | | | | | | | |
| | Process oil | 0 | 0 | 0 | 0 | 0 | 0 | 0 |
| | Sulfur | 0.5 | 0 | 0.5 | 0.4 | 0.5 | 0.5 | 0.4 |
| | Sulfur donor | | | | | | | |
| | compound -1 | | | | | | | |
| | Sulfur donor | 2.0 | | 2.0 | 5.0 | 2.0 | | |
| | compound -2 | | | | | | | |
| | Sulfur donor | | 4.0 | | | | | |
| | compound -3 | | | | | | | |
| | Sulfur donor | | | | | | 3.0 | 5.0 |
| | compound -4 | | | | | | | |
| | Vulcanization | 2.0 | 0.5 | 2.0 | 1.0 | 2.0 | 2.0 | 2.0 |
| | accelerator -1 | | | | | | | |
| | Vulcanization | 0.3 | | 0.3 | | 0.3 | 0.3 | 0.3 |
| | accelerator -2 | | | | | | | |

The various materials listed in Tables 1 to 4 are as follows.
Natural rubber: SVR CV60
Butadiene rubber-1: cis 1,4-bonded amount 96%, Mooney viscosity (ML₁₊₄) 63 at 100° C., “BUNA-CB21” made by ARLANXEO Co., Ltd.
Butadiene rubber-2: cis 1,4-bonded amount 96%, Mooney viscosity (ML₁₊₄) 44 at 100° C., “BR-01” made by ENEOS Material Corporation.
Butadiene rubber-3: cis 1,4-bonded amount 35%, Mooney viscosity (ML₁₊₄) 59 at 100° C., “BR1250H” made by ZEON Corporation.
Anti-aging agent-1: N,N′-Di-2-naphthyl-p-phenylenediamine, “Nocrack White” made by OUCHI SHINKO CHEMICAL INDUSTRIAL CO., LTD.
Anti-aging Agent-2: 2-mercaptobenzimidazole zinc salt, “Nocrack MBZ” made by OUCHI SHINKO CHEMICAL INDUSTRIAL CO., LTD.
Anti-aging agent-3: (N-phenyl-N′-(1,3-dimethylbutyl)-P-phenylenediamine), “Nocrack 6C” made by OUCHI SHINKO CHEMICAL INDUSTRIAL CO., LTD.
Anti-aging agent-4: 2-mercaptobenzimidazole, “Nocrack MB” made by OUCHI SHINKO CHEMICAL INDUSTRIAL CO., LTD.
Anti-aging Agent-5: 2-mercaptomethylbenzimidazole, “Nocrack MMB” made by OUCHI SHINKO CHEMICAL INDUSTRIAL CO., LTD.
Anti-aging agent-6: N-phenyl-N′-(3-methacryloyloxy-2-hydroxypropyl)-p-phenylenediamine, “Nocrack G-1” made by OUCHI SHINKO CHEMICAL INDUSTRIAL CO., LTD.
Vulcanizing agent: Sulfur, “GOLDEN FLOWER POWDER SULFUR 200 MESH” made by Tsurumi Chemical Industry Co., Ltd.
Sulfur Donor Compound-1: Tetrakis(2-ethylhexyl)thiuram disulfide, “Nocceler G-1” made by OUCHI SHINKO CHEMICAL INDUSTRIAL CO., LTD.
Sulfur Donor Compound-2: 2-(4-morpholinodithio)benzothiazole, “Nocceler MDB-P” made by OUCHI SHINKO CHEMICAL INDUSTRIAL CO., LTD.
Sulfur Donor Compound-3: Tetramethylthiuram disulfide, “Nocceler TT-P” made by OUCHI SHINKO CHEMICAL INDUSTRIAL CO., LTD.
Sulfur Donor Compound-4: 4,4′-dithiodimorpholine, “Vulnoc R” made by OUCHI SHINKO CHEMICAL INDUSTRIAL CO., LTD.
Vulcanization Accelerator-1: (N-cyclohexyl-2-benzothiazolylsulfenamide), “Nocceler CZ-G” made by OUCHI SHINKO CHEMICAL INDUSTRIAL CO., LTD.
Vulcanization Accelerator-2: 1,3-diphenylguanidine, “Nocceler D-P” made by OUCHI SHINKO CHEMICAL INDUSTRIAL CO., LTD.
Carbon black-1: Nitrogen adsorption specific surface area 47 m²/g (MAF grade), “Niteron #10” made by NIPPON STEEL Chemical & Material Co., Ltd.
Carbon black-2: Nitrogen adsorption specific surface area 22 m²/g (SRF-HS grade), “Asahi #52” made by Asahi Carbon Co., Ltd.
Paraffin wax: (Wax) “OZOACE 0100” made by NIPPON SEIRO CO., LTD.
Composite zinc oxide: “META-Z-L60” made by Inoue Calcium Corporation.
Stearic acid: “STEARIC ACID CAMELLIA” made by Nippon Oil and Fats Company, Limited.
Naphthenic oil: “Chrisef Oil H56 made by ENEOS Corporation.

<<Preparation of Evaluation Sample (Vulcanized Rubber)>>

[Preparation of Vulcanized Rubber Sheet for Measuring Tensile Characteristic and Characteristic after Heat Aging]

In each of the anti-vibration rubber compositions of Examples 1-13 and Comparative Examples 1-15 shown in Tables 1 to 4, vulcanization molding was performed at 160° C. for a vulcanization time of 10 minutes by compression molding using a mold for a 2 mm sheet with a cavity that has an approximate thickness of 2 mm, and a vulcanized rubber sheet having a thickness of 2 mm (hereinafter simply referred to as “evaluation rubber sheet”) was obtained.

### [Preparation of Vulcanized Rubber Test Piece for Compression Set Test]

Each of the anti-vibration rubber compositions of Examples 1-13 and Comparative Examples 1-15 shown in Tables 1 to 4 was vulcanized and molded at 160° C. for a vulcanization time of 15 minutes by compression molding using a compression mold for preparing a cylindrical test piece having 29.0 mm in diameter×12.5 mm in height to obtain a cylindrical vulcanized rubber test piece having 29.0 mm in diameter×12.5 mm in height for Type A durometer hardness and a compression set test (hereinafter referred to simply as “rubber test piece”).

### [Preparation of Test Piece of Anti-Vibration Rubber]

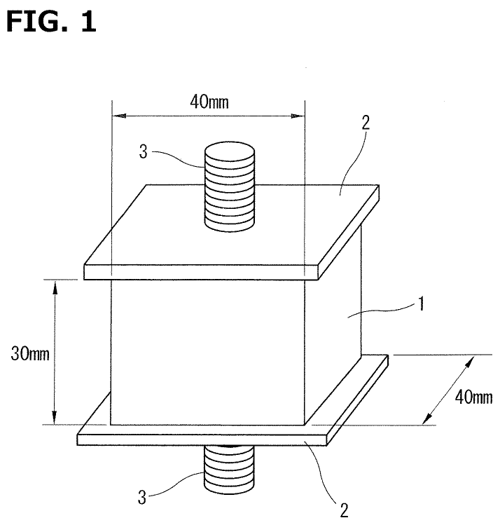

To prepare a test piece 1 of an anti-vibration rubber shown in FIG. 1, two 50 mm×50 mm steel fittings 2 each of which has one surface having a bolt 3 erected in the center were first prepared, and the surface of each of the fitting 2 on which the bolt 3 is not erected was shot-blasted to roughen the surface. Next, Chemrock 205 (made by Lord Far East Inc.) was applied as a primer-coat adhesive to the surface of each of the fittings 2 on which the bolt 3 was not erected, and it was dried at 80° C. for 20 minutes to form a primer-coat adhesive layer (thickness of 10 μm). After cooling each of the fittings 2 formed with the primer-coat adhesive layer to room temperature, Chemulock 6125 (made by Lord Far East Inc.) as a top-coat adhesive was applied on the surface of the above primer-coat adhesive layer, and it was dried at 80° C. for 20 minutes to form a top-coat adhesive layer (thickness of 10 μm). Then, each of fittings 2 was disposed in the mold for molding (disposed to have a posture in which the top-coat adhesive layers of the respective fittings 2 face each other), and an injection molding machine was used to fill the space between the fittings 2 in the mold for molding with unvulcanized rubber (anti-vibration rubber composition) and vulcanize (160° C.×15 min) to prepare a test piece 1 of a square anti-vibration rubber with the fittings 2 formed into a 40 mm×40 mm×30 mm rectangular shape as shown in FIG. 1.

### <<Test Method, Evaluation Method and Judgement of Anti-Vibration Rubber Composition (Vulcanized Rubber)>>

The test and evaluation methods for the anti-vibration rubber compositions (vulcanized rubber) of Examples 1-13 and Comparative Examples 1-15 listed in Tables 1 to 4 are as follows. In addition, the result of each evaluation and judgement is shown in Tables 5 to 8 below.

### [Initial Physical Properties: Type A Durometer Hardness]

Four rubber sheets of each rubber sheet for evaluation, obtained using the anti-vibration rubber compositions of Examples 1-13 and Comparative Examples 1-15 listed in Tables 1 to 4, were prepared and laminated to obtain a laminated sheet (for example, a four-layer laminated sheet having a thickness of approximately 8 mm). Then, in each of the laminated sheets, hardness (HA) was measured using a Type A durometer in accordance with JIS K6253-3 (2012).

### [Initial Physical Properties: Tensile Properties]

In each of rubber sheets for evaluation obtained using the respective anti-vibration rubber compositions of Examples 1-13 and Comparative Examples 1-15 listed in Tables 1 to 4, elongation at break (EB) and tensile strength at break (TB) were measured in accordance with JIS K 6251 by punching with a No. 3 JIS dumbbell.

### [Compression Set Rate]

In each of the rubber test pieces obtained using the respective anti-vibration rubber compositions of Examples 1-13 and Comparative Examples 1-listed in Tables 1 to 4, in accordance with JIS K6262 (2013), by using a jig, it was made in a state of being compressed by 25.0% in the height direction (height of 9.38 mm), and left in a gear-type aging test machine (forced circulation-type aging test machine) at an atmosphere temperature of 100° C. for 22 hours, following which the jig was removed and the rubber test piece was immediately released. After this release, the rubber test piece was left on a wooden stand at 23° C. for 30 minutes, and the height of the rubber test piece (h1) was measured to calculate the compression set CS (%).

The calculation method (formula) for the compressive set CS is based on JIS K6262 (2013) and is shown in a formula (1) below.

CS (%)=((h0−H1)/(h0−hs))×100 (1)

In addition, in this formula (1), h0 indicates the thickness (mm) of a rubber test piece before the compression, h1 indicates the thickness (mm) of a rubber test piece after the removal from a compression device, and hs indicates the thickness (mm) of a spacer used.

The smaller the value of the compression set CS calculated by the formula (1), the smaller the compression set rate and the better the heat settling resistance. Therefore, as an evaluation judgement, the case where the above compression set CS (%) is less than 30% is judged as “O”, the case where CS (%) is 30% or higher and less than 35% is judged as “O”, and the case where CS (%) is 35% or higher is judged as “x”.

### [Heat Aging Resistance—1]

In each of the rubber sheets for evaluation obtained using the anti-vibration rubber compositions of Examples 1-13 and Comparative Examples 1-listed in Tables 1 to 4, it was first punched out with a JIS No. 3 dumbbell, and according to JIS K 6257, a heat aging test was conducted by holding it in the gear-type aging test machine (forced circulation-type aging test machine) at an atmosphere temperature of 100° C. for various holding times (72 hours, 168 hours, 240 hours, 336 hours, 500 hours, 1000 hours, and 1500 hours).

Next, hardness (HA), elongation at break (EB), and tensile strength at break (TB) after the heat aging test were measured in the same manner as in the above item [Initial physical properties].

Then, AHA (Duro-A) was obtained from the difference in hardness (HA) before and after the heat aging test. In addition, the rate of changes AcEB (%) and AcTB (%) (rate of change of the value after the aging test relative to the value before the heat aging test) were obtained from the elongation at break (EB) and tensile strength at break (TB) before and after the heat aging test, respectively.

In addition, as evaluation judgement, when both AcEB (%) and AcTB (%) at 1000 hours of holding time (heat aging time) in the heat aging test were 50% or less, it was judged as “O”, and in the judgement of “O”, when the AcEB (%) at the holding time of 1500 hours was 60% or less, it was judged as “O”. In addition, even if both or one of AcEB (%) and AcTB (%) at the holding time of 1000 hours exceeded 50%, when both AcEB (%) and AcTB (%) were 60% or less, there is a possibility that the tested product can be used as heat resistant rubber, and it was judged as “Δ”. Moreover, the case where AcEB (%) at the holding time of 1000 hours exceeded 60% was judged as “x”.

### [Initial Vibration Characteristics: Static Characteristic Ks, Dynamic Characteristic Kd100, Dynamic Magnification]

In each of the test pieces 1 obtained using the respective anti-vibration rubber compositions of Examples 1-13 and Comparative Examples 1-15, first, in accordance with JISK 6385 (2012), compression and decompression process was repeated twice by applying an axial load through each of the bolts 3 and compressing it axially (in the direction of the bolt 3 axis) by 5 mm (at a displacement speed of 10 mm/min), and then once by decompressing it (at a displacement speed of 10 mm/min). After that, by compressing it again by 5 mm (that is, the third loading process), the load-deflection characteristics at the time of the compression (third loading process) were measured, and a load-deflection curve was created based on this measurement. Then, from the load-deflection curve, load values P1 and P2 (unit: N) when the deflection reached 2 mm and 4 mm were read, respectively, and a static spring constant Ks (N/mm) was calculated by substituting the load values P1 and P2 into the formula “Ks=(P2−P1)/2” as appropriate.

In addition, apart from this, a test was conducted in which each of the test pieces 1 was axially compressed by 3 mm via each of the bolts 3 in the same manner as described above, and constant displacement harmonic compression vibration with an amplitude of ±0.05 mm centered at the 3 mm compressed position was applied from one of the bolts 3 of corresponding one of the compressed test pieces 1 (for example, from the lower side in the drawing) at a frequency of 100 Hz, and the dynamic spring constant Kd100 (N/mm) at 100 Hz was obtained in accordance with the “non-resonance method (a)” in “Test Methods for Vibration Isolation Rubber” of JIS-K-6385-2012. Then, the dynamic magnification (=Kd100/Ks) was calculated from the obtained dynamic spring constant (Kd100) and the static spring constant (Ks) calculated above.

The dynamic magnification is a value which greatly varies depending on the type and content of the polymer and carbon blacks to be used, as mentioned above. Although a smaller dynamic magnification is better, the balance with reinforcement and the like is required. Therefore, in the evaluation judgement, the dynamic magnification (1.56) when the anti-vibration rubber composition of Example 1 was used was defined as a judgement standard value, and when the dynamic magnification was +8% or less than the judgement standard value (that is, 1.68 or less), it was judged as “O”, and when the dynamic magnification was a value more than +8% higher than the judgement standard value (that is, more than 1.68), it was judged as “x”.

### [Heat Aging Resistance—2]

In each of the test pieces 1 obtained using the respective anti-vibration rubber compositions of Examples 1-13 and Comparative Examples 1-15, the test piece 1 was first subjected to the heat aging test by holding it in a gear-type aging test machine (forced circulation-type aging test machine) at an atmosphere temperature of 100° C. for various holding times (72 hours, 168 hours, 240 hours, 336 hours, 500 hours, 1000 hours, and 1500 hours).

Next, after the heat aging test (after removing the test piece 1 from the gear-type aging test machine), the test piece 1 was left at an atmosphere temperature of 23° C. for between 16 hours and 3 days, and then the static spring constant (Ks) was measured in the same manner as in the above item [Initial vibration characteristics].

Then, the change rate (rate of change of the value after the heat aging test relative to the value before the heat aging test) AcKs (%) was obtained from the difference in the static spring constant (Ks) before and after the heat aging test, respectively.

In addition, as the evaluation judgement, “⊚” was judged when all AcKs (%) from 72 hours to 1500 hours of holding time (heat aging time) in the heat aging test were +25 or less. Moreover, the case where AcKs (%) is not “⊚” but the AcKs (%) at the holding time of 1000 hours was +30 or less and the AcKs (%) at a holding time of 1500 hours was +40 or less was judged as “O”. Further, the case where AcKs (%) at a holding time of 1000 hours exceeds +30 and/or AcKs (%) at a holding time of 1500 hours exceeds +40 was judged as “x”.

### [Heat Resistance Adhesion Test—1, 2]

In the heat resistance adhesion test—1, in each of the test pieces 1 obtained using the respective anti-vibration rubber compositions of Examples 1-13 and Comparative Examples 1-15, first, it was held for 60 minutes in a gear-type aging test machine (forced circulation-type aging test machine) at an atmosphere temperature of 100° C. in a state of being elongated (in FIG. 1, elongated in the vertical direction in the drawing) by 50% via each of the bolts 3 in the same manner as mentioned above, and adhesive peeling of each of the bolts 2 was visually observed. After that, the test piece 1 was held for 30 minutes in an atmosphere that was further heated by 10° C. each, and the visual check for adhesive peeling of each of the fittings 2 was repeated in each atmosphere. Finally, the test piece 1 was hold in an atmosphere temperature of 200° C. for 30 minutes to check the adhesive peeling of each of the fittings 2, and then the test was completed.

In this heat resistance adhesion test—1, the higher the temperature at which the adhesive peeling of each of the fittings 2 was suppressed, the better the heat resistance adhesion was judged to be. In Tables 5 to 8, the highest temperatures at which the adhesive peeling was suppressed were listed. For example, when there was no adhesive peeling at 160° C. and the adhesive peeling occurred at 170° C., it was described as “160° C.” in Tables 5 to 8. In addition, when the adhesive peeling was suppressed even at 200° C., it was described as “200° C. OK”.

In addition, in the heat resistance adhesion test—1, two test pieces 1 were prepared using each of the anti-vibration rubber compositions of Examples 1-13 and Comparative Examples 1-15, and of the test results for the two test pieces 1, the one with the lower peeling temperature was adopted as the index of the heat resistance adhesion by the heat resistance adhesion test—1.

Next, in the heat resistance adhesion test—2, each of the test pieces 1, which is the same as in the heat resistance test—1, is first held in a gear-type aging test machine (forced circulation-type aging test machine) for various holding times (24 hours, 48 hours, and 72 hours) at an atmosphere temperature of 100° C. in a state of being elongated (in FIG. 1, elongated in the vertical direction) by 40% via each of the bolts 3 in the same manner as described above, and after each of the holding times elapses, each of the fittings 2 was visually observed for adhesive peeling.

Then, the test piece 1, for which no adhesive peeling was observed after a holding time of 72 hours (after 72 hours had elapsed), was continued to be held in the test machine at an atmosphere temperature of 100° C. for several days (30 days after first being placed in the test machine), and then each of the fittings 2 was visually observed for adhesive peeling.

In the heat resistance adhesion test—2, two test pieces 1 were prepared using each of the anti-vibration rubber compositions of Examples 1 to 13 and Comparative Examples 1 to 15, and one of the results of the test of the two test pieces 1, which had faster adhesive peeling, was adopted as the index of the heat resistance adhesion by the heat resistance adhesion test—2. In Tables 5 to 8, the case where there was no adhesive peeling of each of the fittings 2 after 30 days of holding in the test machine is described as “30 days O”.

In addition, as evaluation judgement, when the heat resistance limit temperature (highest temperature at which adhesive peeling was suppressed) in the heat resistance test—1 was 170° C. or higher and a result of “30 days O” in the heat resistance test—2 was obtained, it was judged as “O”. Moreover, when even if the heat resistance limit temperature was less than 170° C. in the heat resistance test—1, a result of “30 days O” in the heat resistance test—2 was obtained, it was judged as “O”. Further, when a result of “30 days O” was not obtained in the heat resistance adhesion test—2 (when adhesive peeling occurred before 30 days had elapsed in the test machine), it was judged as “x”.

### [Overall Judgement]

If there was one “x” result in each of the above evaluation judgments, it was judged as “x” in the overall judgment. In addition, in each of the above evaluation judgements, if there is no “x” result and there is one or less of “Δ” result (other items were “O” or “⊚”), the overall judgment was judged as “O”.

TABLE 5

| | | | Composition of anti-vibration rubber used | | | |
|---|---|---|---|---|---|---|
| | | | Example 1 | Example 2 | Example 3 | Example 4 |
| Initial physical | | HA | 55 | 55 | 55 | 55 |
| property | | EB (%) | 600 | 600 | 590 | 590 |
| | | TB (MPa) | 25.2 | 25.2 | 24.5 | 25.1 |
| Compression | | CS (%) | 27 | 27 | 29 | 29 |
| set rate | | Judgement | ⊚ | ⊚ | ⊚ | ⊚ |
| Heat aging | 72 H | AHA | +4 | +4 | +3 | +4 |
| resistance-1 | | AcEB (%) | −5 | −7 | −6 | −5 |
| | | AcTB (%) | −5 | −4 | −6 | −4 |
| | 240 H | AHA | +5 | +5 | +5 | +5 |
| | | AcEB (%) | −9 | −10 | −9 | −8 |
| | | AcTB (%) | −10 | −10 | −12 | −11 |
| | 336 H | AHA | +6 | +6 | +7 | +7 |
| | | AcEB (%) | −13 | −14 | −15 | −16− |
| | | AcTB (%) | −17 | −19 | −18 | −19 |
| | 500 H | AHA | +7 | +7 | +7 | +8 |
| | | AcEB (%) | −18 | −18 | −19 | −18 |
| | | AcTB (%) | −25 | −23 | −27 | −26 |
| | 1000 H | AHA | +8 | +9 | +8 | +9 |
| | | AcEB (%) | −33 | −38 | −35 | −37 |
| | | AcTB (%) | −44 | −45 | −45 | −47 |
| | 1500 H | AHA | +10 | +11 | +9 | +10 |
| | | AcEB (%) | −53 | −56 | −55 | −55 |
| | | AcTB (%) | −56 | −61 | −57 | −60 |
| | Judgement | | ⊚ | ⊚ | ⊚ | ⊚ |
| Initial vibration | | Ks | 379 | 383 | 388 | 377 |
| characteristic | | (N/mm) | | | | |
| | | Kd100 | 591 | 594 | 594 | 599 |
| | | (N/mm) | | | | |
| | | Kd100/Ks | 1.56 | 1.55 | 1.53 | 1.59 |
| | | (—) | | | | |
| | | Judgement | ◯ | ◯ | ◯ | ◯ |
| | | | (standard) | | | |
| Heat aging | 72 H | AcKs (%) | +4.9 | +4.7 | +5.1 | +3.2 |
| resistance-2 | 240 H | AcKs (%) | +6.9 | +7.0 | +8.1 | +6.1 |
| | 336 H | AcKs (%) | +9.3 | +9.6 | +10.0 | +8.7 |
| | 500 H | AcKs (%) | +11.9 | +12.3 | +11.2 | +12.0 |
| | 1000 H | AcKs (%) | +23.4 | +24.5 | +23.5 | +24.1 |
| | 1500 H | AcKs (%) | +34.1 | +35.6 | +32.6 | +32.8 |

| | | | | |
|---|---|---|---|---|
| Judgement | ◯ | ◯ | ◯ | ◯ |

| Heat resistance | Heat | 200° | C. OK | 200° | C. OK | 200° | C. OK | 200° | C. OK |
|---|---|---|---|---|---|---|---|---|---|
| adhesion | resistance | | | | | | | | |
| | adhesion | | | | | | | | |
| | test-1 | | | | | | | | |
| | Heat | 30 | days ◯ | 30 | days ◯ | 30 | days ◯ | 30 | days ◯ |

| | | resistance | | | | |
|---|---|---|---|---|---|---|
| | | adhesion | | | | |
| | | test-2 | | | | |
| | | Judgement | ⊚ | ⊚ | ⊚ | ⊚ |
| Overall judgment | | | ◯ | ◯ | ◯ | ◯ |
| | | | Composition of anti-vibration rubber used | | | |
| | | | Example 5 | Example 6 | Example 7 | Example 8 |
| Initial physical | | HA | 55 | 54 | 55 | 57 |
| property | | EB (%) | 580 | 600 | 570 | 610 |
| | | TB (MPa) | 24.9 | 25.5 | 22.5 | 18.9 |
| Compression | | CS (%) | 25 | 23 | 27 | 25 |
| set rate | | Judgement | ⊚ | ⊚ | ⊚ | ⊚ |
| Heat aging | 72 H | AHA | +4 | +4 | +4 | +4 |
| resistance-1 | | AcEB (%) | −9 | −5 | −4 | −8 |
| | | AcTB (%) | −7 | −4 | −5 | −4 |
| | 240 H | AHA | +6 | +5 | +5 | +6 |
| | | AcEB (%) | −14 | −8 | −9 | −13 |
| | | AcTB (%) | −16 | −12 | −11 | −14 |
| | 336 H | AHA | +7 | +7 | +6 | +8 |
| | | AcEB (%) | −17 | −14 | −15 | −18 |
| | | AcTB (%) | −22 | −19 | −17 | −22 |
| | 500 H | AHA | +8 | +9 | +7 | +9 |
| | | AcEB (%) | −23 | −22 | −20 | −23 |
| | | AcTB (%) | −26 | −23 | −25 | −24 |
| | 1000 H | AHA | +10 | +10 | +8 | +9 |
| | | AcEB (%) | −40 | −36 | −39 | −40 |
| | | AcTB (%) | −48 | −44 | −45 | −44 |
| | 1500 H | AHA | +12 | +12 | +10 | +12 |
| | | AcEB (%) | −60 | −57 | −56 | −59 |
| | | AcTB (%) | −64 | −59 | −62 | −63 |
| | Judgement | | ⊚ | ⊚ | ⊚ | ⊚ |
| Initial vibration | | Ks | 385 | 365 | 371 | 415 |
| characteristic | | (N/mm) | | | | |
| | | Kd100 | 608 | 591 | 597 | 544 |
| | | (N/mm) | | | | |
| | | Kd100/Ks | 1.58 | 1.62 | 1.61 | 1.31 |
| | | (—) | | | | |
| | | Judgement | ◯ | ◯ | ◯ | ◯ |
| Heat aging | 72 H | AcKs (%) | +5.1 | +5.3 | +4.9 | +4.7 |
| resistance-2 | 240 H | AcKs (%) | +10.1 | +10.7 | +7.2 | +9.5 |
| | 336 H | AcKs (%) | +13.9 | +13.6 | +9.6 | +12.8 |
| | 500 H | AcKs (%) | +16.2 | +17.5 | +12.2 | +16.9 |
| | 1000 H | AcKs (%) | +25.9 | +27.5 | +24.4 | +27.5 |
| | 1500 H | AcKs (%) | +38.1 | +39.2 | +36.2 | +37.2 |

| | | | | |
|---|---|---|---|---|
| Judgement | ◯ | ◯ | ◯ | ◯ |

| Heat resistance | Heat | 190° | C. | 180° | C. | 200° | C. OK | 170° | C. |
|---|---|---|---|---|---|---|---|---|---|
| adhesion | resistance | | | | | | | | |
| | adhesion | | | | | | | | |
| | test-1 | | | | | | | | |
| | Heat | 30 | days ◯ | 30 | days ◯ | 330 | days ◯ | 30 | days ◯ |

| | | | | |
|---|---|---|---|---|
| resistance | | | | |
| adhesion | | | | |
| test-2 | | | | |
| Judgement | ⊚ | ⊚ | ⊚ | ⊚ |

| | | | | |
|---|---|---|---|---|
| Overall judgment | ◯ | ◯ | ◯ | ◯ |

TABLE 6

| | | | Composition of anti-vibration rubber used | | | | |
|---|---|---|---|---|---|---|---|
| | | | Example 9 | Example 10 | Example 11 | Example 12 | Example 13 |
| Initial physical | | HA | 57 | 57 | 57 | 56 | 56 |
| property | | EB (%) | 550 | 540 | 550 | 560 | 560 |
| | | TB (MPa) | 25.5 | 24.7 | 23.2 | 23.1 | 23.8 |
| Compression | | CS (%) | 31 | 29 | 32 | 31 | 33 |
| set rate | | Judgement | ◯ | ⊚ | ◯ | ◯ | ◯ |
| Heat aging | 72 H | AHA | +4 | +4 | +3 | +3 | +4 |
| resistance-1 | | AcEB (%) | −9 | −7 | −9 | −3 | −11 |
| | | AcTB (%) | −16 | −9 | −13 | −7 | −18 |
| | 240 H | AHA | +6 | +6 | +6 | +5 | +6 |
| | | AcEB (%) | −18 | −17 | −18 | −14 | −20 |
| | | AcTB (%) | −27 | −23 | −19 | −17 | −23 |
| | 336 H | AHA | +7 | +8 | +7 | +6 | +7 |
| | | AcEB (%) | −22 | −21 | −23 | −18 | −25 |
| | | AcTB (%) | −29 | −26 | −25 | −22 | −27 |
| | 500 H | AHA | +8 | +9 | +8 | +7 | +8 |
| | | AcEB (%) | −26 | −25 | −29 | −26 | −33 |
| | | AcTB (%) | −31 | −28 | −31 | −26 | −31 |
| | 1000 H | AHA | +10 | +11 | +10 | +9 | +11 |
| | | AcEB (%) | −48 | −44 | −47 | −42 | −50 |
| | | AcTB (%) | −50 | −47 | −46 | −45 | −52 |
| | 1500 H | AHA | +13 | +13 | +13 | +10 | +13 |
| | | AcEB (%) | −69 | −67 | −68 | −63 | −70 |
| | | AcTB (%) | −74 | −72 | −72 | −70 | −73 |
| | Judgement | | ◯ | ◯ | ◯ | ◯ | Δ |
| Initial vibration | | Ks | 405 | 409 | 401 | 398 | 395 |
| characteristic | | (N/mm) | | | | | |
| | | Kd100 | 587 | 593 | 589 | 605 | 604 |
| | | (N/mm) | | | | | |
| | | Kd100/Ks | 1.45 | 1.45 | 1.47 | 1.52 | 1.53 |
| | | (—) | | | | | |
| | | Judgement | ◯ | ◯ | ◯ | ◯ | ◯ |
| Heat aging | 72 H | AcKs (%) | +0.3 | +0.5 | +1.8 | +1.2 | +1.4 |
| resistance-2 | 240 H | AcKs (%) | +3.0 | +3.5 | +4.5 | +4.0 | +4.7 |
| | 336 H | AcKs (%) | +4.8 | +5.1 | +6.6 | +5.3 | +6.3 |
| | 500 H | Acks (%) | +7.4 | +7.7 | +8.0 | +6.6 | +7.6 |
| | 1000 H | AcKs (%) | +9.7 | +11.6 | +11.5 | +10.7 | +11.7 |
| | 1500 H | AcKs (%) | +17.1 | +19.9 | +16.4 | +19.1 | +20.1 |

| | | | | | |
|---|---|---|---|---|---|
| Judgement | ⊚ | ⊚ | ⊚ | ⊚ | ⊚ |

| Heat resistance | Heat | 150° | C. | 150° | C. | 150° | C. | 140° | C. | 170° | C. |
|---|---|---|---|---|---|---|---|---|---|---|---|
| adhesion | resistance | | | | | | | | | | |
| | adhesion | | | | | | | | | | |
| | test-1 | | | | | | | | | | |
| | Heat | 30 | days ◯ | 30 | days ◯ | 30 | days ◯ | 30 | days ◯ | 30 | days ◯ |

| | | | | | |
|---|---|---|---|---|---|
| resistance | | | | | |
| adhesion | | | | | |
| test-2 | | | | | |
| Judgement | ◯ | ◯ | ◯ | ◯ | ⊚ |

| | | | | | |
|---|---|---|---|---|---|
| Overall judgment | ◯ | ◯ | ◯ | ◯ | ◯ |

TABLE 7

| | | | Composition of anti-vibration rubber used | | | |
|---|---|---|---|---|---|---|
| | | | Comparative | Comparative | Comparative | Comparative |
| | | | Example 1 | Example 2 | Example 3 | Example 4 |
| Initial physical | | HA | 56 | 56 | 55 | 55 |
| property | | EB (%) | 550 | 600 | 590 | 590 |
| | | TB (MPa) | 23.6 | 24.3 | 24.5 | 24.5 |
| Compression | | CS (%) | 23 | 27 | 28 | 35 |
| set rate | | Judgement | ⊚ | ⊚ | ⊚ | X |
| Heat aging | 72 H | AHA | +5 | +4 | +5 | +4 |
| resistance-1 | | AcEB (%) | −13 | −15 | −12 | −8 |
| | | AcTB (%) | −20 | −15 | −14 | −7 |
| | 240 H | AHA | +8 | +6 | +6 | +5 |
| | | AcEB (%) | −29 | −26 | −23 | −13 |
| | | AcTB (%) | −33 | −28 | −25 | −21 |
| | 336 H | AHA | +10 | +8 | +7 | +7 |
| | | AcEB (%) | −39 | −32 | −30 | −18 |
| | | AcTB (%) | −45 | −37 | −37 | −31 |
| | 500 H | AHA | 13 | 10 | 9 | 7 |
| | | AcEB (%) | −52 | −41 | −39 | −23 |
| | | AcTB (%) | −58 | −48 | −42 | −38 |
| | 1000 H | AHA | +14 | +12 | +10 | +9 |
| | | AcEB (%) | −70 | −63 | −58 | −43 |
| | | AcTB (%) | −72 | −67 | −63 | −54 |
| | 1500 H | AHA | +16 | +13 | +11 | +10 |
| | | AcEB (%) | −82 | −78 | −71 | −62 |
| | | AcTB (%) | −80 | −75 | −74 | −69 |
| | Judgement | | X | X | X | Δ |
| Initial vibration | | Ks | 394 | 392 | 381 | 381 |
| characteristic | | (N/mm) | | | | |
| | | Kd100 | 595 | 620 | 629 | 621 |
| | | (N/mm) | | | | |
| | | Kd100/Ks | 1.51 | 1.58 | 1.65 | 1.63 |
| | | (−1) | | | | |
| | | Judgement | ◯ | ◯ | ◯ | ◯ |
| Heat aging | 72 H | AcKs (%) | +7.6 | +2.2 | +1.9 | +5.1 |
| resistance-2 | 240 H | AcKs (%) | +16.5 | +10.7 | +7.7 | +10.9 |
| | 336 H | AcKs (%) | +19.4 | +15.8 | +12.1 | +15.7 |
| | 500 H | AcKs (%) | +25.8 | +20.8 | +17.9 | +18.6 |
| | 1000 H | AcKs (%) | +43.2 | +35.2 | +28.7 | +27.5 |
| | 1500 H | AcKs (%) | +59.5 | +49.6 | +43.6 | +40.5 |

| | | | | |
|---|---|---|---|---|
| Judgement | X | X | X | X |

| Heat resistance | Heat | 160° | C. | 200° | C. OK | 200° | C. OK | 200° | C. OK |
|---|---|---|---|---|---|---|---|---|---|
| adhesion | resistance | | | | | | | | |
| | adhesion | | | | | | | | |
| | test-1 | | | | | | | | |
| | Heat | 30 | days ◯ | 30 | days ◯ | 30 | days ◯ | 30 | days ◯ |

| | | resistance | | | | |
|---|---|---|---|---|---|---|
| | | adhesion | | | | |
| | | test-2 | | | | |
| | | Judgement | ◯ | ◯ | ◯ | ◯ |
| Overall judgment | | | X | X | X | X |
| | | | Composition of anti-vibration rubber used | | | |
| | | | Comparative | Comparative | Comparative | Comparative |
| | | | Example 5 | Example 6 | Example 7 | Example 8 |
| Initial physical | | HA | 55 | 55 | 54 | 54 |
| property | | EB (%) | 600 | 590 | 580 | 600 |
| | | TB (MPa) | 25.2 | 25.1 | 24.9 | 25.5 |
| Compression | | CS (%) | 30 | 31 | 38 | 43 |
| set rate | | Judgement | ◯ | ◯ | X | X |
| Heat aging | 72 H | AHA | +6 | +4 | +4 | +4 |
| resistance-1 | | AcEB (%) | −11 | −13 | −6 | −13 |
| | | AcTB (%) | −13 | −14 | −5 | −15 |
| | 240 H | AHA | +7 | +5 | +5 | +5 |
| | | AcEB (%) | −22 | −24 | −8 | −21 |
| | | AcTB (%) | −26 | −28 | −10 | −26 |
| | 336 H | AHA | +8 | +7 | +6 | +7 |
| | | AcEB (%) | −29 | −32 | −13 | −27 |
| | | AcTB (%) | −36 | −39 | −15 | −34 |
| | 500 H | AHA | 9 | 8 | 7 | 9 |
| | | AcEB (%) | −39 | −40 | −17 | −37 |
| | | AcTB (%) | −47 | −47 | −23 | −45 |
| | 1000 H | AHA | +11 | +9 | +8 | +10 |
| | | AcEB (%) | −61 | −59 | −33 | −57 |
| | | AcTB (%) | −68 | −64 | −42 | −67 |
| | 1500 H | AHA | +13 | +11 | +10 | +12 |
| | | AcEB (%) | −75 | −74 | −52 | −70 |
| | | AcTB (%) | −78 | −77 | −56 | −77 |
| | Judgement | | X | X | ◯ | X |
| Initial vibration | | Ks | 379 | 377 | 385 | 365 |
| characteristic | | (N/mm) | | | | |
| | | Kd100 | 656 | 603 | 608 | 675 |
| | | (N/mm) | | | | |
| | | Kd100/Ks | 1.73 | 1.60 | 1.58 | 1.85 |
| | | (−1) | | | | |
| | | Judgement | X | ◯ | ◯ | X |
| Heat aging | 72 H | AcKs (%) | +1.8 | +2.3 | +4.8 | +4.9 |
| resistance-2 | 240 H | AcKs (%) | +8.4 | +8.5 | +6.8 | +10.2 |
| | 336 H | AcKs (%) | +11.9 | +12.2 | +9.5 | +14.8 |
| | 500 H | AcKs (%) | +19.5 | +19.7 | +11.8 | +20.5 |
| | 1000 H | AcKs (%) | +32.5 | +30.2 | +24.3 | +33.3 |
| | 1500 H | AcKs (%) | +46.5 | +44.1 | +33.9 | +45.2 |

| | | | | |
|---|---|---|---|---|
| Judgement | X | X | ◯ | X |

| Heat resistance | Heat | 200° | C. OK | 200° | C. OK | 190° | C. | 180° | C. |
|---|---|---|---|---|---|---|---|---|---|
| adhesion | resistance | | | | | | | | |
| | adhesion | | | | | | | | |
| | test-1 | | | | | | | | |
| | Heat | 30 | days ◯ | 30 | days ◯ | 30 | days ◯ | 30 | days ◯ |

| | | | | |
|---|---|---|---|---|
| resistance | | | | |
| adhesion | | | | |
| test-2 | | | | |
| Judgement | ◯ | ◯ | ◯ | ◯ |

| | | | | |
|---|---|---|---|---|
| Overall judgment | X | X | X | X |

TABLE 8

| | | | Composition of anti-vibration rubber used | | | | | | |
|---|---|---|---|---|---|---|---|---|---|
| | | | Comparative | Comparative | Comparative | Comparative | Comparative | Comparative | Comparative |
| | | | Example 9 | Example 10 | Example 11 | Example 12 | Example 13 | Example 14 | Example 15 |
| Initial physical | | HA | 57 | 57 | 56 | 55 | 56 | 57 | 57 |
| property | | EB (%) | 550 | 550 | 550 | 570 | 560 | 530 | 510 |
| | | TB (MPa) | 23.6 | 25.5 | 25.5 | 22.5 | 23.1 | 23.7 | 21.8 |
| Compression | | CS (%) | 30 | 15 | 33 | 27 | 34 | 35 | 31 |
| set rate | | Judgement | ◯ | ⊚ | ◯ | ⊚ | ◯ | X | ◯ |
| Heat aging | 72 H | AHA | +4 | +7 | +4 | +4 | +5 | +6 | +5 |
| resistance-1 | | AcEB (%) | −15 | −17 | −13 | −4 | −15 | −15 | −10 |
| | | AcTB (%) | −20 | −23 | −18 | −5 | −21 | −19 | −15 |
| | 240 H | AHA | +7 | +9 | +7 | +6 | +8 | +7 | +6 |
| | | AcEB (%) | −24 | −32 | −26 | −15 | −23 | −23 | −19 |
| | | AcTB (%) | −26 | −35 | −24 | −17 | −26 | −25 | −22 |
| | 336 H | AHA | +8 | +12 | +8 | +6 | +9 | +9 | +7 |
| | | AcEB (%) | −31 | −44 | −33 | −25− | −30 | −35 | −30 |
| | | AcTB (%) | −35 | −49 | −30 | −28 | −34 | −39 | −35 |
| | 500 H | AHA | 10 | 14 | 10 | 7 | 10 | 11 | 9 |
| | | AcEB (%) | −45 | −61 | −44 | −34 | −41 | −49 | −42 |
| | | AcTB (%) | −49 | −68 | −47 | −37 | −49 | −51 | −47 |
| | 1000 H | AHA | +12 | +15 | +12 | +8 | +12 | +13 | +10 |
| | | AcEB (%) | −65 | −75 | −63 | −53 | −60 | −70 | −63 |
| | | AcTB (%) | −68 | −77 | −65 | −56 | −68 | −75 | −69 |
| | 1500 H | AHA | +14 | +17 | +14 | +10 | +14 | +15 | +13 |
| | | AcEB (%) | −80 | −83 | −78 | −63 | −74 | −79 | −70 |
| | | AcTB (%) | −81 | −84 | −81 | −66 | −83 | −81 | −77 |
| | Judgement | | X | X | X | Δ | X | X | X |
| Initial vibration | | Ks | 405 | 395 | 398 | Initial | 395 | 411 | Initial |
| characteristic | | (N/mm) | | | | adhesion | | | adhesion |
| | | Kd100 | 579 | 585 | 609 | NG | 581 | 584 | NG |
| | | (N/mm) | | | | Test stop | | | Test stop |
| | | Kd100/Ks | 1.43 | 1.48 | 1.53 | | 1.47 | 1.42 | |
| | | Judgement | ◯ | ◯ | ◯ | | ◯ | ◯ | |
| Heat aging | 72 H | AcKs (%) | +0.2 | +8.1 | +0.8 | | +3.8 | +2.4 | |
| resistance-2 | 240 H | AcKs (%) | +5.7 | +18.5 | +4.1 | | +6.7 | +7.0 | |
| | 336 H | AcKs (%) | +8.5 | +23.4 | +7.5 | | +8.5 | +9.2 | |
| | 500 H | AcKs (%) | +14.4 | +30.5 | +14.0 | | +10.4 | +12.5 | |
| | 1000 H | AcKs (%) | +29.5 | +48.7 | +30.5 | | +12.9 | +16.2 | |
| | 1500 H | AcKs (%) | +51.4 | +64.1 | +50.1 | | +15.9 | +25.5 | |

| | | | | | |
|---|---|---|---|---|---|
| Judgement | X | X | X | ⊚ | ◯ |

| Heat resistance | Heat | 150° | C. | 120° C. | 150° | C. | 150° | C. | 120° C. |
|---|---|---|---|---|---|---|---|---|---|
| adhesion | resistance | | | | | | | | |
| | adhesion | | | | | | | | |
| | test-1 | | | | | | | | |
| | Heat | 30 | days ◯ | 24 hours | 30 | days ◯ | 30 | days ◯ | 48 hours |

| | | | | | | | |
|---|---|---|---|---|---|---|---|
| resistance | | peeling | | | | peeling | |
| adhesion | | | | | | | |
| test-2 | | | | | | | |
| Judgement | ◯ | X | ◯ | X | ◯ | X | X |

| | | | | | | | |
|---|---|---|---|---|---|---|---|
| Overall judgment | X | X | X | X | X | X | X |

### Results of Verification by Comparison of Examples 1-13 and Comparative Examples 1-15

The blending ratio of each of the various materials shown in Tables 1 to 4 and the results shown in Tables 5 to 8 indicate the following.

First, in each of the anti-vibration rubber compositions of Examples 1 to 8, the main rubber components are natural rubber (NR) and/or isoprene rubber (IR) and butadiene rubber (BR), and when the total rubber component is 100 parts by mass, 2-mercaptobenzimidazole zinc salt is contained within the range of 1.8 to 5 parts by mass and N,N′-Di-2-naphthyl-p-phenylenediamine is contained within the range of 0.2 to 1.1 parts by mass, and, in addition, sulfur is contained within the range of 0.2 to 0.7 parts by mass as a vulcanizing agent and tetrakis(2-ethylhexyl)thiuram disulfide is contained within the range of 2 to 7 parts by mass as a sulfur donor compound (hereinafter simply referred to as Examples 1 to 8 categorical compositions).

Then, according to the compositions under the categories of Examples 1 to 8, extremely excellent results were obtained in terms of compression set rate (heat settling resistance), heat resistance (in the item [heat aging resistance—1], the lowing in material properties after long-term heat aging is small), initial vibration characteristics (low dynamic magnification), and heat adhesion resistance. In addition, the change in vibration characteristics (change in anti-vibration characteristics after long-term heat aging in the test piece 1 (thick anti-vibration rubber) in the item [heat aging resistance—2]) is also small, and it can be understood that an extremely excellent heat-resistant anti-vibration rubber compositions and heat-resistant anti-vibration rubber can be obtained.

On the other hand, in each of the anti-vibration rubber compositions of Comparative Examples 1-8, as compared to the compositions under the categories of Example 1 to 8, the composition differs in at least one of the type and content of each of the anti-aging agents, sulfur and sulfur donor compounds, and it is found that “x” is judged in at least one of the evaluation judgments shown in Table 7.

Next, in each of the anti-vibration rubber compositions of Examples 9 to 13, natural rubber (NR) and/or isoprene rubber (IR) and butadiene rubber (BR) are the main rubber components, and when total rubber component is 100 parts by mass, 2-mercaptobenzimidazole zinc salt is contained within the range of 1.8 to 5 parts by mass and N,N′-Di-2-naphthyl-p-phenylenediamine is contained within the range of 0.2 to 1.1 parts by mass, and, in addition, sulfur is contained within the range of 0.2 to 0.7 parts by mass as a vulcanizing agent and 2-(4-morpholinodithio)benzothiazole is contained within the range of 1.2 to 3 parts by mass as a sulfur donor compound (hereinafter simply referred to as Example 9-13 categorical compositions).

Then, according to the compositions under the categories of Example 9-13, in particular, the change in vibration characteristics (change in anti-vibration characteristics after long-term heat aging in the test piece 1 (thick anti-vibration rubber) in the item [heat aging resistance-2]) is extremely small, and it indicates that better results have been obtained. In addition, in terms of compression set rate (heat settling resistance) and heat resistance (item [heat aging resistance-1]), the decrease in physical properties is small until the holding time reaches 1000 hours at an atmosphere temperature of 100° C., and it indicates that excellent heat resistance has been obtained. As to heat resistance adhesion, although there was case where adhesion under a heat atmosphere significantly exceeding 100° C. was insufficient, sufficient adhesion was obtained even after 30 days of tensile stress under a heat atmosphere of 100° C., and it can be used sufficiently as a heat-resistant anti-vibration rubber composition. In addition, the results for compression set rate (heat settling resistance) and initial vibration characteristics (low dynamic magnification) are also found to be sufficiently good.

On the other hand, in each of the anti-vibration rubber compositions of Comparative Examples 9-15, as compared to the compositions under the categories of Example 9-13, the composition differs in at least one of the type and content of each of the anti-aging agents, sulfur and sulfur donor compounds, and it is found that “x” is judged in at least one of the evaluation judgments shown in Table 8.

In addition, although each of the anti-vibration rubber compositions in Comparative Examples 12 and 15 contained a large amount of 2-(4-morpholinodithio)benzothiazole or 4,4′-dithiodimorpholine as a sulfur donor compound, in the test piece 1, which was made by using each of them, since peeling occurred easily between a metal fitting 2 and a rubber part by hand force, it was judged to be unsuitable as an anti-vibration rubber with fittings, and the test using the test piece 1 was stopped.

When focused on the butadiene rubber used in the anti-vibration rubber compositions of Examples 1-13, in the compositions under the categories of Example 1-8 and Examples 9-13, it was confirmed that by setting the Mooney viscosity (ML₁₊₄) of the butadiene rubber at 100° C. to a value within the range of 50-75, anti-vibration properties (low dynamic magnification) and rubber strength were improved further and more favorable results were obtained.

According to the above results, the anti-vibration rubber compositions in Examples 1-8 categorical compositions can be said to be extremely excellent anti-vibration rubber compositions because they show a small decrease in material properties even under extremely long-term thermal environments (for example, an extremely long period of time of 1500 hours at 100° C.) and have excellent heat settling resistance, vibration characteristics, and heat resistance adhesion.

Further, the anti-vibration rubber compositions in Examples 9-13 categorical compositions can be said to be extremely excellent anti-vibration rubber compositions because they show a small change in vibration characteristics of anti-vibration rubber even under extremely long-term heat environments (for example, an extremely long period of time of 1500 hours at 100° C.), a small decrease in physical properties even under long-term thermal environments (for example, a long period of time of 1000 hours at 100° C.), and have excellent heat settling resistance and vibration characteristics, and with regard to heat resistance adhesion, no adhesive peeling occurs even when tensile stress is continuously applied under extremely long-term thermal conditions (for example, 30 days at 100° C.).

### EXPLANATION OF SIGNS

1 . . . Test piece
2 . . . Fitting
3 . . . Bolt (supporting rod)

1. An anti-vibration rubber composition containing, as main rubber components, a natural rubber (NR) and/or an isoprene rubber (IR) and a butadiene rubber (BR), comprising:
2-mercaptobenzimidazole zinc salt;
N,N′-Di-2-naphthyl-p-phenylenediamine;
sulfur; and
tetrakis(2-ethylhexyl)thiuram disulfide,
wherein when a total rubber component in the anti-vibration rubber composition is 100 parts by mass, the 2-mercaptobenzimidazole zinc salt is contained within a range of 1.8 to 5 parts by mass, the N,N′-Di-2-naphthyl-p-phenylenediamine is contained within a range of 0.2 to 1.1 parts by mass, the sulfur is contained within a range of 0.2 to 0.7 parts by mass, and the tetrakis(2-ethylhexyl)thiuram disulfide is contained within a range of 2 to 7 parts by mass.

2. An anti-vibration rubber composition containing, as main rubber components, a natural rubber (NR) and/or an isoprene rubber (IR) and a butadiene rubber (BR), comprising:
2-mercaptobenzimidazole zinc salt;
N,N′-Di-2-naphthyl-p-phenylenediamine;
sulfur; and
2-(4-morpholinodithio)benzothiazole,
wherein when a total rubber component in the anti-vibration rubber composition is 100 parts by mass, the 2-mercaptobenzimidazole zinc salt is contained within a range of 1.8 to 5 parts by mass, the N,N′-Di-2-naphthyl-p-phenylenediamine is contained within a range of 0.2 to 1.1 parts by mass, the sulfur is contained within a range of 0.2 to 0.7 parts by mass, and the 2-(4-morpholinodithio)benzothiazole is contained within a range of 1.2 to 3 parts by mass.

3. The anti-vibration rubber composition according to claim 1, wherein the main rubber components are a blend rubber of the natural rubber (NR) and the butadiene rubber (BR) with an NR/BR ratio of 90/10 to 60/40 in the ratio of the natural rubber (NR) to the butadiene rubber (BR), and
wherein the butadiene rubber has a Mooney viscosity (ML₁₊₄) of 50-75 at 100° C.

4. The anti-vibration rubber composition according to claim 2, wherein the main rubber components are a blend rubber of the natural rubber (NR) and the butadiene rubber (BR) with an NR/BR ratio of 90/10 to 60/40 in the ratio of the natural rubber (NR) to the butadiene rubber (BR), and
wherein the butadiene rubber has a Mooney viscosity (ML₁₊₄) of 50-75 at 100° C.

5. An anti-vibration rubber having the anti-vibration rubber composition according to claim 1 which is vulcanized and bonded to a surface of a fitting via an adhesive layer on the surface of the fitting, such that the fitting and a vulcanized rubber with the anti-vibration rubber composition are integrally formed.

6. An anti-vibration rubber having the anti-vibration rubber composition according to claim 2 which is vulcanized and bonded to a surface of a fitting via an adhesive layer on the surface of the fitting, such that the fitting and a vulcanized rubber with the anti-vibration rubber composition are integrally formed.

7. An anti-vibration rubber having the anti-vibration rubber composition according to claim 3 which is vulcanized and bonded to a surface of a fitting via an adhesive layer on the surface of the fitting, such that the fitting and a vulcanized rubber with the anti-vibration rubber composition are integrally formed.

8. An anti-vibration rubber has the anti-vibration rubber composition according to claim 4 which is vulcanized and bonded to a surface of a fitting via an adhesive layer on the surface of the fitting, such that the fitting and a vulcanized rubber with the anti-vibration rubber composition are integrally formed.
